(19) United States
(12) Patent Application Publication
(10) Pub. No.: US 2013/0124042 A1
(43) Pub. Date: May 16, 2013

(54) Driver-Assistance System Having Control of the Vehicle Brake System and Distance Warning

(71) Applicants: Florian Raisch, Gaertringen (DE); Meike Fehse, Rutesheim (DE)

(72) Inventors: Florian Raisch, Gaertringen (DE); Meike Fehse, Rutesheim (DE)

(21) Appl. No.: 13/641,795

(22) PCT Filed: Apr. 26, 2011
(86) PCT No.: PCT/EP2011/056516

§ 371 Date: Dec. 26, 2012

(30) Foreign Application Priority Data
May 11, 2010 (DE) 102010028830.6

(51) Int. Cl. B62D 15/02

(52) U.S. Cl. CPC B62D 15/0285
USPC 701/41

(57) ABSTRACT

The present system relates to driver-assistance systems providing a parking-assistance functionality, in which a vehicle brake system is actively controlled. Among other components, the parking assistance system includes a parking device for implementing a parking operation along a calculated parking trajectory, and an output device for outputting distance information about detected objects to a man-machine interface. The parking device is configured to brake only for the at least one parking-space-delimiting object (PLBO) detected prior to the parking operation, but not for a non-parking-space-delimiting object (non-PLBO) detected in the course of the parking operation. The output device is configured to output to the MMI only distance information about the non-PLBO, but no distance information about the PLBO during the parking operation.

### FIELD OF THE INVENTION

The present invention relates to driver-assistance systems, especially systems providing a parking-assistance functionality, in which a vehicle brake system is actively controlled.

### BACKGROUND INFORMATION

A parking-assistance functionality supports the driver in parking a vehicle. In so doing, the assistance system measures a parking space while passing it, and then guides the driver into the measured parking space. The guidance may be a passive guidance; in this case, steering angle inputs as well as start-driving and stopping instructions are transmitted to the driver via a user interface or a man-machine interface (MMI). However, guidance may also occur in active form, in which case the driver receives only start-driving or stopping inputs, while the system assumes the transverse and longitudinal guidance. Corresponding systems are discussed, for example, in DE 10 2004 047 484 A1 or EP 1 270 367 A2.

During the parking maneuver the vehicle environment is monitored by distance-measuring sensors disposed in the bumpers, for instance. The distances to obstacles are indicated to the driver and the driver is warned of looming collisions if appropriate. In the case of systems having (semi)automatic longitudinal guidance, brake interventions take place that are aimed at end points of the parking trajectory, i.e., stopping and turning points at the end of a parking space, but also brake interventions aimed at detected static or dynamic obstacles, i.e., suddenly occurring obstacles.

In DE 60 2004 005 053 T2, a parking-assistance method is discussed in which a temporal change rate of a braking force is modified. In situations in which an obstacle is not stationary but comes closer to the vehicle or moves away from it, this allows for a rapid adaptation of the brake force to the new position of the obstacle. When there is a risk that a moving obstacle will be touched, a red lamp is activated on a dashboard. In this case the driver may decide to step on the brake pedal.

### SUMMARY OF THE INVENTION

A driver-assistance system having semiautomatic longitudinal guidance induces a braking operation only with regard to stop or turning points of a previously calculated parking trajectory. The stopping points refer to at least one parking-space-delimiting object (“PLBO”), which had been measured by the sensor system prior to parking, e.g., when driving past the parking space. When entering the parking space, the sensor system verifies the distance to the PLBO and, if necessary, the system adapts the distance still to be covered until reaching the stop. The system does not brake for previously undetected, possibly temporary, i.e., suddenly occurring, obstacles along the parking trajectory. This constitutes an appropriate response in many situations, such as when the temporary object is a person who crosses the parking space in a grazing manner and then immediately departs the space again. However, informing the driver is very important; the MMI of the parking assistance system must inform the driver in clear and directly comprehensible form for which objects the driver must brake on his/her own, and for which objects, such as the at least one PLBO, the system brakes automatically. That is to say, the driver must be enabled to brake himself when the parking assistance system determines that an object is being approached which is not part of the delimitation of the parking space (i.e., a non-parking-space-delimiting object “non-PLBO”), e.g., an obstacle along the parking trajectory, because the system does not brake for a non-PLBO. On the other hand, however, the parking assistance system brakes for the previously detected PLBO(s), and the driver should trust the system in this regard.

According to the exemplary embodiments and/or exemplary methods of the present invention, a parking assistance system is provided which has an input device for accepting data from a sensor system. The sensor system is set up to detect at least one PLBO prior to the parking operation. In addition, the system has a calculation device for calculating a parking trajectory based on the detected at least one PLBO. The system furthermore is provided with a parking device for performing the parking operation along the calculated parking trajectory. Finally, the system includes an output device for outputting distance information about detected objects to an MMI. The parking device is configured to brake only for the at least one PLBO detected prior to parking during a parking operation, but not for a non-PLBO detected while engaged in parking. The output device is configured to output only distance information relating to the non-PLBO to the MMI, but no distance information for the PLBO during the parking operation.

As a result, a system is provided in which temporary objects, for example, do not elicit braking interventions, which is the appropriate response in many situations. At the same time, in comparison with conventional systems, an MMI is modified in such a way that the distance to an object such as an obstacle along the parking trajectory, is output only if this obstacle does not constitute the delimitation of the parking space. This enables the driver to quickly and clearly comprehend when he must act on his own, i.e., brake or stop in front of a (temporary) object by himself, if appropriate.

The output device may also be configured to output the distance information for the non-PLBO, if the non-PLBO is detected as obstacle along the parking trajectory. In one specific embodiment thereof, the output device is developed to output distance information about the non-PLBO if a distance of the non-PLBO is less than a path to be covered during the parking operation until a stopping or turning point of the trajectory used has been reached. That is to say, if a non-PLBO is detected which is closer to the vehicle than the next stopping point, then the driver is informed of this fact. A non-PLBO, for instance, may also be a PLBO detected prior to parking. Particularly situations in which a PLBO is mobile come to mind in this context, in particular.

The distance output may include a distance warning, which is output to the output device if a drop below a predefined minimum distance has occurred. In this specific embodiment, the non-PLBO is brought to the driver's attention only if, and not until, a drop below the minimum distance is at hand. This avoids unnecessary warnings, for example.

Multiple MMIs may be provided, such as an acoustic and an optical interface to the driver. In this case the output device may be set up for outputs to two or more MMIs. Only distance information about the non-PLBO is output to the first one of the two MMIs, e.g., an acoustic MMI, during the parking operation under these circumstances, but no distance information about the PLBO. At the same time, distance information about the PLBO is output to a second MMI, e.g., an optical MMI, during parking. Additionally, it is also possible to use this second MMI to output distance information relating to the non-PLBO. As a result, a direct (acoustic) warning may be restricted to a potential collision with a temporary obstacle along the parking trajectory, while a complete representation of the vehicle environment continues to be output via an optical display. Alternatively, it is also possible to omit a PLBO in the optical representation as well.

The output device may be developed in such a way that distance information relating to non-PLBOs is output to the second MMI, even if they do not constitute an obstacle along the parking trajectory. This makes it possible, for example, to still represent an object that does not lie on the current driving envelope and furthermore does not constitute a parking space delimitation, for instance in order to serve as orientation aid for the driver during the maneuvering.

According to the exemplary embodiments and/or exemplary methods of the present invention, a driver assistance system which includes a parking assistance system as described above, is provided in addition.

Additional aspects and advantages of the exemplary embodiments and/or exemplary methods of the present invention will now be described in greater detail with reference to the attached figures.

### BRIEF DESCRIPTION OF THE DRAWINGS

FIG. 1 shows functional components of a parking system according to the present invention, in the form of a schematic block diagram.

FIG. 2 shows a manner of functioning of the system from FIG. 1, in the form of a flow chart.

FIG. 3 shows an exemplary parking operation, in schematic form, to further illustrate the method of functioning of the system from FIG. 1.

### DETAILED DESCRIPTION

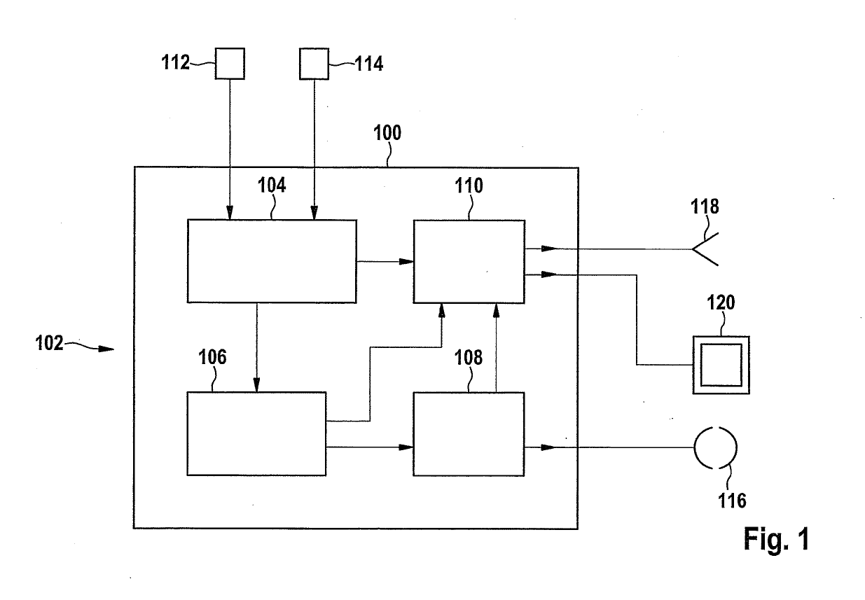

FIG. 1 schematically illustrates the essential functional components of a parking assistance system 100 in the present invention, which parking assistance system 100, for instance, may be part of an otherwise not further illustrated parking assistance system 102 in a passenger car. System 100 includes a data receiver device 104, a calculation device 106, a parking device 108, as well as an output device 110.

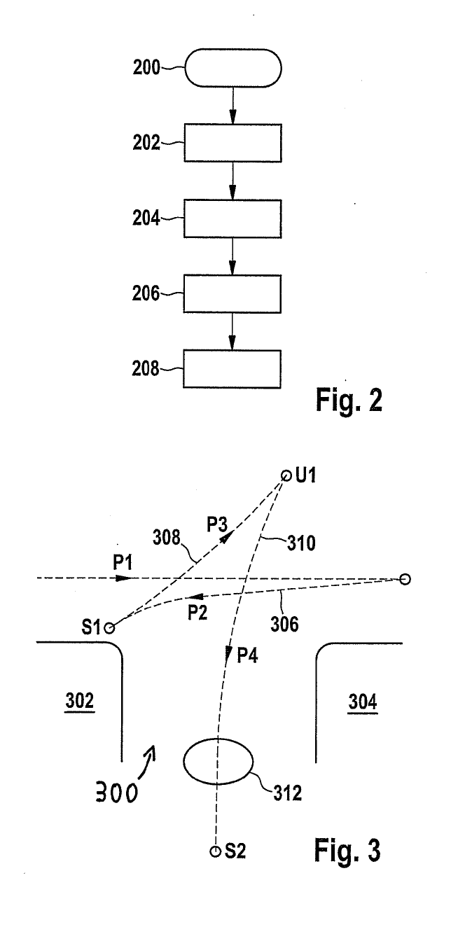

A method of functioning of system 100 will be described in the following text with reference to the flow chart shown in FIG. 2. To elucidate matters, reference is also made to an exemplary parking operation outlined in FIG. 3. There, the trajectory of a vehicle (not shown) is illustrated, which includes a passing-by phase P1 and a parking trajectory P2, P3, P4.

In phase P1, the vehicle drives past a parking space 300, which is delimited by parking-space delimiting objects (PLBOs) 302 and 304. In this phase P1 sensors 112 and 114 measure parking space 300, that is to say, PLBOs 302 and 304 are detected. The two sensors 112 and 114 may be, for instance, an ultrasonic, a radar or an infrared sensor or a similar sensor, which are mounted on a left and right fender of the vehicle.

In step 202 in FIG. 2, data receiver device 104 receives data from sensor system 112, 114 formed by sensors 112, 114, the data relating to detected PLBO(s) 302 and 304.

The driver makes the decision to park in parking space 300. System 100 now implements a parking assistance function that features an active control of a vehicle brake system in order to park in parking space 300. In a step 204, device 104 forwards the data from sensor system 112, 114 to calculation device 106. Based on at least one of the two PLBOs 302 or 304, device 106 calculates a parking trajectory, which is composed of a path 306 extending to stopping position S1, a path 308 from S1 to a turning position U1, and a path 310 from U1 to a final stopping position S2.

In step 206, calculation device 106 appropriately controls parking device 108 in order to implement parking along calculated parking trajectory 306-310. Toward this end, parking device 108 may control a (schematically sketched) brake system 116 of the vehicle, for example. An important aspect is that the parking maneuver includes an active braking process when one of points S1, U1 and S2 is approached (i.e., in each phase P2, P3, and P4).

A schematically sketched object 312, which has not been detected in phase P1 because it is a mobile obstacle, for instance, is located in parking space 300. Object 312 is detected only after phase P1 has ended and it is detected as non-PLBO, since it is not located at the position of PLBOs 302 or 304 detected in phase P1, for example. Non-PLBO 312 constitutes an obstacle because the object is located within the travel path envelope, i.e., along calculated parking trajectory 306-310. Calculation device 106 and/or parking device 108 are/is developed to perform the parking maneuver featuring phases P2-P4 and the braking processes embedded therein, but not to implement any active brake control when detecting an obstacle such as obstacle 312.

In step 208, output device 110 receives signals from the other devices 104-108 of parking assistance system 100 in order to output distance information about detected objects, such as objects 302, 304 and 312, for instance, to two man-machine interfaces (MMIs) 118 and 120. Device 118, for instance, may be an acoustic output device such as a loudspeaker, and output device 120 may be an optical output device such as a display screen, for example.

Output device 110 is set up to output only distance information in connection with detected non-PLBOs to MMI 118 during the parking operation (phase P2 through P4), but no distance information relating to PLBOs. In the event that the acoustic output includes the output of a distance warning as soon as a drop below a minimum distance occurs when approaching a non-PLBO, then there would be no acoustic output during phases P2 and P3 in the specific scenario of FIG. 3, but it would certainly occur during phase P4 when approaching non-PLBO 312.

Output device 110 simultaneously outputs distance information about all detected objects to optical MMI 120. As a result, no acoustic signal is output via MMI 118 during phase P2, because system 100 automatically brakes when stopping point S1 is approached. An acoustic warning or distance information relating to PLBO 302 is therefore not required or would confuse the driver. However, to guide the driver, distances or positions or dimensions of PLBOs 302 and 304 are able to be displayed to the driver on display screen 120. Even obstacle 312 may be displayed there, provided it has already been detected.

There is also no output of distance information via acoustic MMI 118 during phase P3, because parking assistance system 100 carries out another automatic braking operation when turning point U1 along trajectory 308 is approached, so that no driver intervention is required. However, to guide the driver, it is possible, as before, to output the entire vehicle environment to optical MMI 120, including PLBOs 302 and 304 and possibly non-PLBO 312.

When the vehicle approaches non-PLBO 312 along trajectory 310 during phase P4, an acoustic output, i.e., distance warning, takes place in order to signal to the driver that he must perform active braking himself in this case to avoid a potential collision with obstacle 312. In this situation, collision obstacle 312 may either continue to be displayed on display screen 120 (PLBOs 302 and 304 could be blanked out), or obstacle 312 may be contrasted with respect to PLBOs 302 and 304 in some other suitable manner.

In the event that non-PLBO 312 disappears, i.e., is no longer detected, while the vehicle is approaching along trajectory 310, no further distance output takes place via acoustic MMI 118, since stopping point S2 is reached by automatic braking interventions of parking assistance system 100, regardless of whether or not an additional PLBO is situated behind point S2.

The detection of an object as PLBO or non-PLBO may take place with the aid of ascertained distance values. Once again referring to phase P2 in Figure P2 by way of example, a conventional system would output a distance warning due to an approach of PLBO 302, for instance when the vehicle is moving in the direction of point S1 along trajectory 306. In the system described here, a distance output to acoustic MMI 188, for example, is able to be muted as long as an equivalent distance value with respect to PLBO 302 (taking a safety clearance into account) corresponds to the remaining stretch along path 306 still to be covered until stopping point S1 in front of PLBO 302 has been reached. If PLBO 302 were to move during phase P2 and, for instance, come overly close to stopping point S1 or move beyond it, the equivalent distance value would be reduced and object 302 immediately be classified as a non-PLBO, i.e., no automatic braking would take place, but a distance warning be output via acoustic system 118.

With exemplary reference to phase P4, a distance warning via first MMI 188 because of a detected non-PLBO, for which no automatic braking intervention occurs, may also take place only after a predefined minimum distance to obstacle 312 along path 310 has been undershot. This minimum distance is selectable as a function of speed, for example, to ensure that the driver is able to stop the vehicle before a potential collision occurs.

The present invention is not limited to these exemplary embodiments and the aspects emphasized therein, but instead may be modified in numerous ways known to one skilled in the art.

1-9. (canceled)

10. A parking assistance system, comprising:
an input device for receiving data from a sensor system, the sensor system being configured to detect at least one parking-space-delimiting object prior to parking;
a determining device for determining a parking trajectory based on at least one detected parking-space-delimiting object;
a parking device for implementing the parking operation along the calculated parking trajectory; and
an output device for outputting distance information about detected objects to a man-machine interface;
wherein the parking device is configured not to brake during parking for a non-parking-space-delimiting object detected the course of the parking operation, and
wherein the output device is configured to output to the man-machine interface distance information about the non-parking-space-delimiting object during the parking operation.

11. The system of claim 10, wherein the output device is configured to output the distance information about the non-parking-space-delimiting object when the non-parking-space-delimiting object is detected as obstacle along the parking trajectory.

12. The system of claim 10, wherein the output device is configured to output the distance information about the non-parking-space-delimiting object when a distance of the non-parking-space-delimiting object is less than a path to be traveled in the course of the parking operation until a stopping or turning point of the calculated parking trajectory has been reached.

13. The system of claim 10, wherein the distance output includes a distance warning output by the output device when a drop below a minimum distance has occurred.

14. The system of claim 10, wherein the output device is configured for an output to two man-machine interfaces, so that only distance information about the non-parking-space-delimiting object is output to a first one of the two man-machine interfaces in the course of the parking operation, but no distance information about the parking-space-delimiting object, and distance information about the parking-space-delimiting object is output to a second one of the two man-machine interfaces in the course of the parking operation.

15. The system of claim 14, wherein the output device is adapted to the first man-machine interface having an acoustic man-machine interface.

16. The system of claim 14, wherein the output device is adapted to the second man-machine interface having an optical man-machine interface.

17. The system of claim 14, wherein the output device is configured so that distance information about the non-parking-space-delimiting object is output to the second man-machine interface in the course of the parking operation.

18. The system of claim 14, wherein the output device is configured so that distance information about non-parking-space-delimiting objects, which are not detected as obstacle along the parking trajectory is output to the second man-machine interface.
